(19) United States
(12) Patent Application Publication
(10) Pub. No.: US 2026/0005442 A1
(43) Pub. Date: Jan. 1, 2026

(54) ANTENNA MODULE AND ELECTRONIC DEVICE

(71) Applicant: Lenovo (Beijing) Limited, Beijing (CN)

(72) Inventor: Meijin GUO, Beijing (CN)

(21) Appl. No.: 19/251,753

(22) Filed: Jun. 26, 2025

(30) Foreign Application Priority Data
Jun. 28, 2024 (CN) 202410867231.6

(51) Int. Cl. H01Q 15/00; H01Q 1/22; H01Q 1/24; H01Q 1/38; H01Q 1/52

(52) U.S. Cl. CPC H01Q 15/0086; H01Q 1/2258; H01Q 1/241; H01Q 1/38; H01Q 1/521

(57) ABSTRACT

An antenna module includes an antenna unit and a first isolation unit. The antenna unit includes a first antenna and a second antenna arranged at an interval. The first isolation unit is arranged between the first antenna and the second antenna and configured to convert a transmission form of an electromagnetic wave coupled into the first isolation unit from the first antenna and/or the second antenna into an evanescent wave, to isolate a target signal between the first antenna and the second antenna.

### CROSS-REFERENCE TO RELATED APPLICATION

The present disclosure claims priority to Chinese Patent Application No. 202410867231.6, filed on Jun. 28, 2024, the entire content of which is incorporated herein by reference.

### TECHNICAL FIELD

The present disclosure relates to the antenna technology field and, more particularly, to an antenna module and an electronic device.

### BACKGROUND

In a complex communication environment, wireless network cards stably transmit and receive a signal by using a dual-antenna structure. The dual-antenna structure includes a primary antenna and a secondary antenna. The primary antenna is mainly configured to receive and send a primary radio signal. The secondary antenna is configured to assist the primary antenna in improving the stability and reliability of the network connection.

Since the primary antenna and the secondary antenna have almost the same operation frequency band, and are close to each other, electromagnetic coupling is easily generated between the primary antenna and the secondary antenna. Then, the signal transmission can be interfered with, and the antenna performance and communication quality can be affected. In addition, the electronic device is gradually miniaturized. Thus, the distance between the primary antenna and the secondary antenna is further shortened, and the communication quality is further reduced.

### SUMMARY

An aspect of the present disclosure provides an antenna module, including an antenna unit and a first isolation unit. The antenna unit includes a first antenna and a second antenna arranged at an interval. The first isolation unit is arranged between the first antenna and the second antenna and configured to convert a transmission form of an electromagnetic wave coupled into the first isolation unit from the first antenna and/or the second antenna into an evanescent wave, to isolate a target signal between the first antenna and the second antenna.

An aspect of the present disclosure provides an electronic device, including an antenna module. The antenna module includes an antenna unit and a first isolation unit. The antenna unit includes a first antenna and a second antenna arranged at an interval. The first isolation unit is arranged between the first antenna and the second antenna and configured to convert a transmission form of an electromagnetic wave coupled into the first isolation unit from the first antenna and/or the second antenna into an evanescent wave, to isolate a target signal between the first antenna and the second antenna.

### BRIEF DESCRIPTION OF THE DRAWINGS

FIG. 1 illustrates a schematic structural diagram of an antenna module according to some embodiments of the present disclosure.

FIG. 2A illustrates a schematic top view diagram of a first isolation unit according to some embodiments of the present disclosure.

FIG. 2B illustrates a schematic front view diagram of a first isolation unit according to some embodiments of the present disclosure.

FIG. 3A illustrates a schematic structural diagram of a metal patch according to some embodiments of the present disclosure.

FIG. 3B illustrates a schematic diagram showing an equivalent circuit of a metal patch according to some embodiments of the present disclosure.

FIG. 4 illustrates a schematic diagram showing parameter S of a first isolation unit according to some embodiments of the present disclosure.

FIG. 5 illustrates a schematic diagram showing an imaginary part and a real part of an equivalent dielectric constant of a first isolation unit according to some embodiments of the present disclosure.

FIG. 6 illustrates a schematic diagram showing an imaginary part and a real part of an equivalent magnetic permeability of a first isolation unit according to some embodiments of the present disclosure.

FIG. 7 illustrates a schematic diagram showing an imaginary part and a real part of an equivalent refractive index of a first isolation unit according to some embodiments of the present disclosure.

FIG. 8A illustrates a schematic structural diagram of an antenna module without a first isolation unit according to some embodiments of the present disclosure.

FIG. 8B illustrates a schematic structural diagram of an antenna module with a first isolation unit according to some embodiments of the present disclosure.

FIG. 9A illustrates a schematic structural diagram of an isolation simulation result curve of an antenna module in a 2-7.5 GHz frequency band according to some embodiments of the present disclosure.

FIG. 9B illustrates a schematic structural diagram of an isolation simulation result curve of an antenna module in a 5.15-7.125 GHz frequency band according to some embodiments of the present disclosure.

FIG. 10A illustrates a schematic structural diagram of a surface current distribution simulation result of an antenna module without a first isolation unit according to some embodiments of the present disclosure.

FIG. 10B illustrates a schematic structural diagram of a surface current distribution simulation result of an antenna module with a first isolation unit according to some embodiments of the present disclosure.

FIG. 11A illustrates a schematic structural diagram of a simulation comparison result of an H-plane radiation pattern of a second antenna on the left side before and after a first isolation unit is loaded in a 5.5 GHz frequency band according to some embodiments of the present disclosure.

FIG. 11B illustrates a schematic structural diagram of a simulation comparison result of an H-plane radiation pattern of a second antenna on a left side before and after a first isolation unit is loaded in a 6.0 GHz frequency band according to some embodiments of the present disclosure.

FIG. 11C illustrates a schematic structural diagram of a simulation comparison result of an H-plane radiation pattern of a second antenna on a left side before and after a first isolation unit is loaded in a 6.5 GHz frequency band according to some embodiments of the present disclosure.

FIG. 11D illustrates a schematic structural diagram of a simulation comparison result of an H-plane radiation pattern of a second antenna on a left side before and after a first isolation unit is loaded in a 7.0 GHz frequency band according to some embodiments of the present disclosure.

### DETAILED DESCRIPTION OF THE EMBODIMENTS

Embodiments of the present disclosure are described with reference to the accompanying drawings. However, these descriptions are merely exemplary and are not intended to limit the scope of the present disclosure. To facilitate the description, many specific details are described to provide a full understanding of embodiments of the present disclosure. Apparently, one or more embodiments can also be implemented without these details. Furthermore, descriptions of well-known structures and techniques are omitted below to avoid unnecessarily obscuring the concepts of the present disclosure.

The terms used herein are only for describing specific embodiments and are not intended to limit the present disclosure. The terms “comprising,” “including,” etc., used herein can indicate the presence of the described features, steps, operations, and/or members, but do not preclude the presence or addition of one or more other features, steps, operations, or members.

All terms (including technical and scientific terms) used herein have the meanings commonly understood by those skilled in the art unless otherwise defined. The terms used herein should be interpreted as having meanings consistent with the context of the present disclosure and should not be interpreted in an idealized or overly rigid manner.

An expression similar to “at least one of A, B, or C” can generally be interpreted according to the meaning commonly understood by those skilled in the art. For example, “a system including at least one of A, B, or C” can mean that the system includes, but is not limited to, only A, only B, only C, A and B, A and C, B and C, and/or A, B, and C.

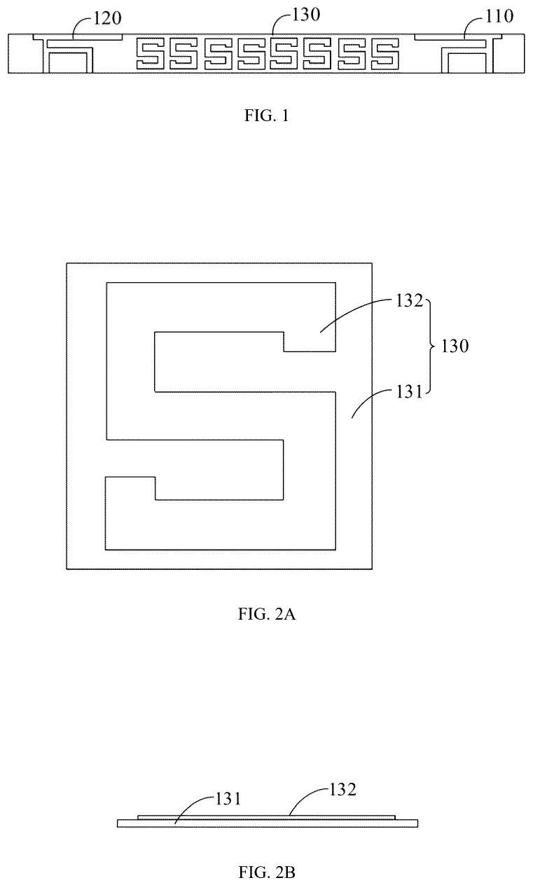

FIG. 1 illustrates a schematic structural diagram of an antenna module according to some embodiments of the present disclosure.

The present disclosure provides an antenna module, including an antenna unit and a first isolation unit 130.

The antenna unit includes a first antenna 110 and a second antenna 120. The first antenna 110 and the second antenna 120 are arranged at an interval. The distance between the first antenna 110 and the second antenna 120 can be set as needed. In practical application, one of the first antenna 110 and the second antenna 120 can be used as a primary antenna, and the other one can be used as a secondary antenna.

The types of the first antenna 110 and the second antenna 120 are not limited in the present disclosure. For example, the first antenna 110 can be a PIFA (Planar Inverted F-shaped Antenna) or another type of antenna. Similarly, the second antenna 120 can be a PIFA or another type of antenna. When both the first antenna 110 and the second antenna 120 are PIFA antennas, the F orientations of the first antenna 110 and the second antenna 120 can be opposite.

A target signal of a specific frequency can be generated due to electromagnetic coupling between the first antenna 110 and the second antenna 120, the target signal can include a high-frequency signal, a low-frequency signal, or a specific-frequency band signal. Taking a WiFi scenario as an example, the target signal can include a WiFi high-frequency operating band, such as a signal in a frequency band of 5.15-5.85 GHz and a signal in a frequency band of 5.925-7.125 GHz, or a low-frequency operating band of 2.4-2.5 GHz. In other scenarios, the frequency of the target signal can be another value, which is not limited to embodiments of the present disclosure.

The first isolation unit 130 can be arranged between the first antenna 110 and the second antenna 120. The first isolation unit 130 can be configured to convert a transmission form of an electromagnetic wave coupled into the first isolation unit 130 into an evanescent wave. The electromagnetic wave can be from at least one of the first antenna 110 or the second antenna 120. Thus, the target signal between the first antenna 110 and the second antenna 120 can be isolated.

According to the technical solution of embodiments of the present disclosure, in the antenna module, the first isolation unit 130 can be arranged between the first antenna 110 and the second antenna 120. The first isolation unit 130 can be configured to convert the transmission form of the electromagnetic wave coupled into the first isolation unit 130 into an evanescent wave. Then, the target signal between the first antenna 110 and the second antenna 120 can be isolated to ensure the antenna performance and communication quality.

According to another embodiment of the present disclosure, the first isolation unit 130 can have an electrical resonance to exhibit single-negative characteristics. The single-negative characteristics can be electrical single-negative characteristics with a negative relative dielectric constant and positive magnetic permeability, or magnetic single-negative characteristics with a positive relative dielectric constant and negative magnetic permeability. The first isolation unit 130 with the single-negative characteristics can be configured to convert the transmission form of the electromagnetic wave coupled into the first isolation unit 130 into the evanescent wave.

In related technologies, the first antenna 110 and the second antenna 120 can be isolated by a branch. However, since the branch may need to be grounded, energy loss is high, and efficiency is low.

In some embodiments, different from the branch, a single-negative medium having a signal-negative characteristic can be used in the first isolation unit 130. The signal-negative medium can belong to a metamaterial, which is an artificial compound medium different from a natural material. By performing layout design on some periodic structures in various sizes and shapes, the metamaterial can obtain a unique electromagnetic characteristic different from a conventional material. In addition, the first isolation unit 130 with a single-negative characteristic can realize the isolation effect without being grounded. Thus, energy loss is low, and efficiency is high.

According to another embodiment of the present disclosure, one or more first isolation units 130 can be provided. The number of first isolation units 130 can be primarily determined by the distance between the first antenna 110 and the second antenna 120, the size of the first isolation unit 130, and the required isolation effect. For example, if the distance between the first antenna 110 and the second antenna 120 is large, more first isolation units 130 can be arranged. If the distance between the first antenna 110 and the second antenna 120 is small, fewer first isolation units 130 can be arranged. For instance, a predetermined number of first isolation units 130 can be arranged between the first antenna 110 and the second antenna 120. The predetermined number can range from 4 to 10, such as 6, 7, or 8.

In some embodiments, as shown in FIG. 1, when a plurality of first isolation units 130 are provided, the plurality of first isolation units 130 can be periodically arranged in a certain order between the first antenna 110 and the second antenna 120. The plurality of isolation units can be arranged in a plurality of rows, which can increase the longitudinal size. In other embodiments, the plurality of isolation units can also be arranged in a single row.

In some embodiments, the size of a single first isolation unit 130 can be smaller than a wavelength of the electromagnetic wave generated by the first antenna 110 or the second antenna 120. Thus, the first isolation unit 130 may require a small space of the electronic device. Thus, the one or more first isolation units 130 can be conveniently arranged and loaded between the first antenna 110 and the second antenna 120. The distance between the first antenna 110 and the second antenna 120 can be small, which can satisfy the miniaturization needs of the electronic device. In some other embodiments, the size of the signal first isolation unit 130 can be greater than the wavelength of the electromagnetic wave. The size of the single first isolation unit 130 is not limited in embodiments of the present disclosure.

FIGS. 2A and 2B illustrate a schematic top view and a schematic front view of the first isolation unit according to embodiments of the present disclosure, respectively.

According to another embodiment of the present disclosure, a single first isolation unit 130 can include a substrate 131 and a metal patch 132. The metal patch 132 can be arranged on the substrate 131. The structure of the first isolation unit 130 can be simple and easy to manufacture.

In some embodiments, when one first isolation unit 130 is provided. The first isolation unit 130 can have a subwavelength structure. The subwavelength structure can refer to a structure with a size much smaller than the operating wavelength of the electromagnetic wave. For example, the sizes of the substrate 131 and the metal patch 132 can be smaller than the wavelength of the electromagnetic wave to meet the miniaturization requirements of the electronic device.

In another example, when one first isolation unit 130 is provided, the size of the substrate 131 can be greater than or equal to the wavelength of the electromagnetic wave generated by the first antenna 110 or the second antenna 120. The size of the metal patch 132 can be smaller than the wavelength of the electromagnetic wave generated by the first antenna 110 or the second antenna 120.

In yet another example, when a plurality of first isolation units 130 are provided, a plurality of substrates 131 can be connected to each other to form an integrated structure. The plurality of metal patches 132 can be arranged at intervals on the integrated substrate 131 in sequence. Then, the size of a single substrate 131 can be smaller than the wavelength of the electromagnetic wave generated by the first antenna 110 or the second antenna 120. The size of the integrated structure formed by the plurality of substrates 131 can be greater than or equal to the wavelength of the electromagnetic wave generated by the first antenna 110 or the second antenna 120. Additionally, the metal patch 132 can have a subwavelength structure.

In some embodiments, the size of a single substrate 131 can be 8±0.2 mm×8±0.2 mm, and the structural size of a single metal patch 132 can be 6±0.2 mm×7.9±0.2 mm. For example, the size of the metal patch 132 in the first direction can be about 6 mm, and the size of the metal patch 132 in the second direction can be about 7.9 mm. The first direction can be a left-right direction in FIG. 2A, and the second direction can be an up-down direction in FIG. 2B.

Furthermore, when the plurality of first isolation units 130 are arranged in a same row, a distance between two metal patches 132 of two neighboring first isolation units 130 can be 1 mm to 3 mm. For example, the distance can be 1.5 mm to 2.5 mm, and particularly can be 2 mm.

In some embodiments, the first isolation unit 130 can be flexible. For example, the substrate 131 can be flexible, and/or the metal patch 132 can be flexible. Thus, the first isolation unit 130 can be suitable for a device environment having a certain curvature shape without affecting the isolation performance of the first isolation unit 130.

In practical applications, the material of the first isolation unit 130 can have various options. For example, the substrate 131 can include a wave-absorbing material to enhance the isolation effect. For example, the substrate 131 can also have a flexible dielectric material to adapt to the device environment with a certain curvature shape. For example, the metal patch 132 can be made of a metal material with good conductivity. The combination of the metal patch 132 and the substrate 131 can also have various options. For example, the metal patch 132 can be processed on the substrate 131 by etching a copper-aluminum foil or using an LDS copper plating process.

In practical applications, some antenna modules can originally include a dielectric substrate. The first antenna 110 and the second antenna 120 can be arranged on the dielectric substrate. For such antenna modules, the originally existing dielectric substrate can be used as the substrate 131 above. Thus, a new substrate 131 is not needed.

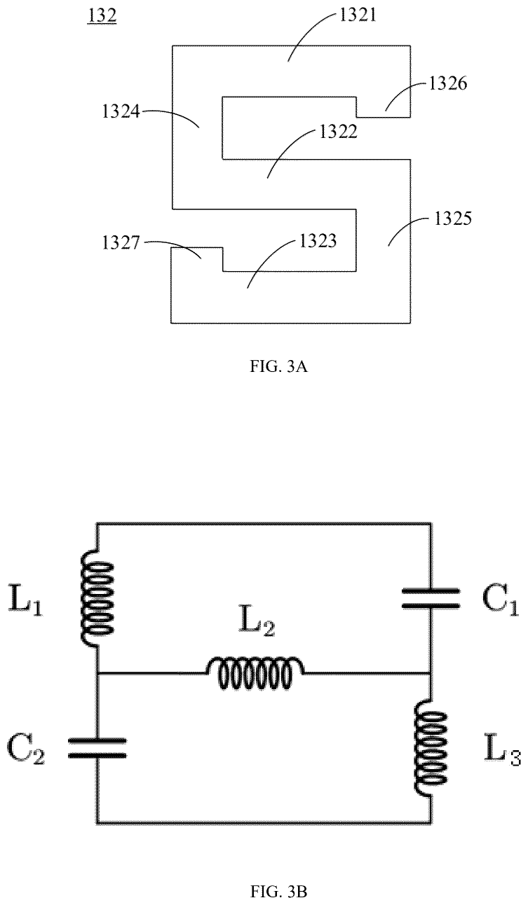

FIG. 3A illustrates a schematic structural diagram of the metal patch according to some embodiments of the present disclosure.

In some other embodiments of the present disclosure, the metal patch 132 in the first isolation unit 130 can be an S-shaped metal patch 132.

For example, in FIG. 3A, the left-right direction is the first direction, the up-down direction is the second direction, and the first direction and the second direction have a predetermined angle therebetween. The predetermined angle can be 90 degrees. The metal patch 132 includes a plurality of metal segments, including a first segment 1321, a second segment 1322, a third segment 1323, a first connection segment 1324, and a second connection segment 1325. The first segment 1321, the second segment 1322, and the third segment 1323 extend along the first direction and are arranged at intervals along the second direction. The first connection segment 1324 and the second connection segment 1325 extend along the second direction. The first end of the first segment 1321 and the first end of the second segment 1322 are connected via the first connection segment 1324. The second end of the first segment 1321 and the second end of the second segment 1322 are isolated. The first end of the second segment 1322 and the first end of the third segment 1323 are isolated. The second end of the second segment 1322 and the second end of the third segment 1323 are connected via the second connection segment 1325. The first segment 1321, the first connection segment 1324, the second segment 1322, the second connection segment 1325, and the third segment 1323 can be sequentially connected end-to-end to form an S-shaped structure. Additionally, the shape of the S-shaped metal patch 132 in the bending area has a right angle. In other embodiments, the shape of the bending area can also have a rounded corner.

For another example, the plurality of metal segments of the metal patch 132 can further include a first protruding segment 1326 and a second protruding segment 1327. The first protruding segment 1326 can be arranged at the second end of the first segment 1321 and extend from the second end of the first segment 1321 toward the direction close to the second segment 1322. The second protruding segment 1327 can be arranged at the first end of the third segment 1323 and extend from the first end of the third segment 1323 toward the direction close to the second segment 1322. Testing has shown that setting the first protruding segment 1326 and the second protruding segment 1327 can improve the isolation effect of the first isolation unit 130.

In another embodiment of the present disclosure, the antenna module can further include a second isolation unit. The second isolation unit can be arranged between the first antenna 110 and the second antenna 120. The second isolation unit 110 can be configured to deflect a transmission direction of an electromagnetic wave generated by the antenna (the first antenna 110 or the second antenna 120 above), or disrupt the interference of an electromagnetic wave to improve the isolation between the first antenna 110 and the second antenna 120.

For example, the second isolation unit can be a left-handed material. The left-handed material can have double-negative characteristics. The double-negative characteristics can mean that the second isolation unit includes a negative dielectric constant and negative magnetic permeability. Then, the second isolation unit can generate a reverse wave or deflect the electromagnetic wave emitted by the first antenna and/or the second antenna. Thus, the isolation between the first antenna 110 and the second antenna 120 can be improved.

In an example, at least one second isolation unit can be arranged at the end of the first isolation unit 130 facing the first antenna 110 to process the electromagnetic wave coupled from the first antenna 110 into the first isolation unit 130.

In another example, at least one second isolation unit can be arranged at the end of the first isolation unit 130 facing the second antenna 120 to process the electromagnetic wave coupled from the second antenna 120 into the first isolation unit 130.

In another example, at least two second isolation units can be provided. The at least two isolation units can be arranged at opposite ends of the first isolation unit 130 facing the first antenna 110 and the second antenna 120. That is, the second isolation units can be arranged on both ends of the first isolation unit 130 to fully isolate the electromagnetic wave coupled from the first antenna 110 and the second antenna 120 into the first isolation unit 130.

In practical applications, the dimensional parameters of the metal patch 132 of the first isolation unit 130 can be flexibly designed according to a specific frequency band in which the antenna performance needs to be improved.

FIG. 3B illustrates a schematic diagram showing an equivalent circuit of the metal patch according to some embodiments of the present disclosure.

When the dimensional parameters are designed, one feasible approach can include performing estimation based on an equivalent circuit model. Then, taking an example for the first isolation unit 130 including the substrate 131 and the metal patch 132, and the metal patch 132 being an S-shaped metal patch 132, the method of performing the estimation based on the equivalent circuit model to determine the dimensional parameters of the first isolation unit 130 can be described.

In some embodiments, the equivalent circuit of the metal patch 132 of the first isolation unit 130 is shown in FIG. 3B. The equivalent circuit includes a first loop and a second loop that are mirror-symmetric. The first loop includes a first capacitance C₁, a first inductance L₁, and a second inductance L₂. The second loop includes a second capacitance C₂, a second inductance L₂, and a third inductance L₃. The first end of the first inductance L₁ is connected to the first end of the second capacitance C₂ and the first end of the second inductance L₂. The second end of the first inductance L₁ is connected to the first end of the first capacitance C₁. The second end of the first capacitance C₁ is connected to the second end of the second inductance L₂ and the first end of the third inductance L₃. The second end of the second capacitance C₂ is connected to the second end of the third inductance L₃.

In some embodiments, the first capacitance C₁ and the second capacitance C₂ can have an equal value, and the first inductance L₁ and the third inductance L₃ can have an equal value.

The equivalent circuit can satisfy the principle of dual-loop mirror symmetry. When an electrical resonance occurs, the equivalent circuit can be split into two symmetric loops. The current direction generated in the first loop by the electromagnetic wave incident from the first antenna 110 and the second antenna 120 can be opposite to the current direction generated in the second loop. Thus, the metamaterial single negative characteristic of the relative dielectric constant of the equivalent medium of the first isolation unit 130 being negative in a certain frequency band can be realized. Then, the transmission form of the electromagnetic wave coupled into the first isolation unit 130 can be converted into an evanescent wave. Meanwhile, the material can have the metamaterial characteristic of having a near-zero refractive index.

For example, the first inductance L₁ can be the same as the third inductance L₃. The resonance frequency f can be represented by formula (1):

$$f = \frac{1}{2 π \sqrt{{C}_{1} ( {L}_{1} + 2 {L}_{2} )}} \qquad ( 1 )$$

where L₁ denotes the first inductance. The first inductance L₁ represents the equivalent inductance of bent metal lines on upper and lower sides of the metal patch 132 of the substrate 131. L₂ denotes the second inductance. The second inductance L₂ represents the equivalent inductance of the middle transverse metal lines. For example, the equivalent inductance of the first segment 1321 and the first connection segment 1324 can be the first inductance L₁. The equivalent inductance of the metal lines of the second segment 1322 can be the second inductance L₂. The equivalent inductance of the third segment 1323 and the second connection segment 1325 can be the third inductance L₃.

According to microstrip line theory, the equivalent inductance value L can be estimated by formula (2):

$$L = 2 \times 1 {0}^{- 4} l [ ln ( \frac{ι}{w + t} ) + 1.193 + 0.2235 \frac{ι}{w + t} ] \qquad ( 2 )$$

where l denotes the length of the metal line, t denotes the thickness of the metal line, and w denotes the width of the metal line. The lengths, thicknesses, and widths of the metal lines corresponding to the first inductance L₂ and the second inductance L₂ are substituted into the formula (2) to calculate the first inductance L₁ and the second inductance L₂.

According to microstrip line theory, the equivalent capacitance value C can be calculated using the following formulas (3) to (6):

$$C = {ε}_{0} {ε}_{e} F ( k ) \qquad ( 3 )$$

$${ε}_{e} = 1 + ( {ε}_{r} - 1 ) F ( k ) / 2 F ( {k}_{1} ) \qquad ( 4 )$$

$$F ( k ) = \{ \begin{matrix}\frac{1}{π} ln ( 2 \frac{1 + \sqrt{{k}^{′}}}{1 - \sqrt{{k}^{′}}} ) , 0 < k \leq \frac{1}{\sqrt{2}} \\ \frac{1}{π} ln {( 2 \frac{1 + \sqrt{k}}{1 - \sqrt{k}} )}^{- 1} , \frac{1}{\sqrt{2}} < k \leq 1\end{matrix} \qquad ( 5 )$$

$$k = \frac{a}{b} , a = \frac{g}{2} , b = a + w , {k}^{′} = \sqrt{1 - {k}^{2}} , {k}_{1} = \frac{sinh ( \frac{π a}{2 h} )}{sinh ( \frac{π b}{2 h} )} \qquad ( 6 )$$

where ε₀ denotes the dielectric constant of free space, εₑ denotes the equivalent dielectric constant, g denotes the distance between a parallel metal line pair (e.g., the distance between protruding segments 1326 and 1327, and second segment 1322), w denotes the width of the metal line, εᵣ denotes the relative dielectric constant of the dielectric substrate 131, and h denotes the thickness of the dielectric substrate 131.

C denotes the equivalent coupling capacitance between parallel metal lines on both sides of the metal patch 132. The relevant parameters of the metal lines corresponding to the first capacitance C₁ and the second capacitance C₂ are substituted into the above formulas (3) to (5). That is, the values of the first capacitance C₁ and the second capacitance C₂ can be calculated. In embodiments of the present disclosure, the first capacitance C₁ and the second capacitance C₂ can have the same value. For example, the first capacitance C₁ and the second capacitance C₂ are C in formular (3).

By substituting the estimated equivalent capacitance and the equivalent inductance values into the formula (1), the resonant frequency of the metal patch 132 can be estimated. Then, according to the required resonant frequency, the microstrip line can be adjusted. The corresponding equivalent capacitance value and the corresponding equivalent inductance value can be changed to adjust the frequency range covered by the negative equivalent dielectric constant.

For example, if the first isolation unit 130 needs to have good isolation in the frequency range of 5 GHz to 7 GHz, but in reality, the first isolation unit 130 has good isolation in the range of 6 GHz to 8 GHz, the resonant frequency of the first isolation unit 130 may need to be lowered. Based on the above formula (1), the equivalent capacitance value may need to be increased, and/or the equivalent inductance value may need to be increased to reduce the resonant frequency. The equivalent capacitance can be increased by increasing the distance between the metal segments of the metal patch 132 or through other adjustment methods. Based on the difference between the required isolation and the actual isolation, the adjustment direction of the size parameter of the metal patch 132 can be determined. Through a plurality of adjustments, the size parameter of the metal patch 132 meeting the requirements can be obtained.

In some other embodiments of the present disclosure, in addition to the estimation based on the equivalent circuit model, calculation can be performed in the S-parameter inversion method by combining with computer electromagnetic simulation software to determine the dimensional parameter of the metal patch 132 in the first isolation unit 130. Then, the S-parameter inversion method combined with the computer electromagnetic simulation software for determining the dimensional parameter of the metal path 130 can be described.

The S-parameter inversion method can include equating the material to a two-port network, obtaining the S-parameters of the material, and obtaining the equivalent medium parameters of the material. The S-parameter inversion method is a common method for studying the characteristics of the metamaterial. The S-parameter can include a scattering parameter and a transmission parameter. When the transmitted energy is less, the isolation can be higher.

For example, full-wave simulation analysis can first be performed on the first isolation unit 130 to obtain the S-parameter of the first isolation unit 130. Then, through theoretical formula derivation, the equivalent dielectric constant and the equivalent permeability of the medium can be obtained. For instance, if the first isolation unit 130 adopts a subwavelength structure, the size of the first isolation unit 130 can be much smaller than the operating wavelength of the electromagnetic wave. Thus, the first isolation unit 130 can be approximated as a homogeneous medium. The S-parameters, the refractive index, and the impedance of the first isolation unit 130 can satisfy formulas (7) and (8):

$$\{ \begin{matrix}n = \frac{1}{k d} {cos}^{- 1} [ \frac{1}{2 {S}_{21}} ( 1 - {S}_{11}^{2} + {S}_{21}^{2} ] \\ z = \sqrt{\frac{{( 1 + {S}_{11} )}^{2} + S {}_{21}^{2}}{{( 1 + {S}_{11} )}^{2} - S {}_{21}^{2}}}\end{matrix} \qquad ( 7 )$$

$$\{ \begin{matrix}ε = \frac{n}{z} \\ μ = nz\end{matrix} \qquad ( 8 )$$

where n denotes the refractive index, z denotes the impedance, & denotes the equivalent dielectric constant, μ denotes the equivalent permeability, S11 denotes the reflection coefficient of one circuit port, and S21 denotes the reflection coefficient of another circuit port.

Through the above formulas (7) and (8), the S-parameter of the first isolation unit 130 can be obtained. Then, the equivalent dielectric constant, the equivalent permeability, and the refractive index corresponding to the equivalent medium can be obtained inversely. Then, the material characteristic analysis can be performed on the equivalent medium.

For example, whether the equivalent dielectric constant satisfies the electrical single negative characteristic can be determined first. If yes, the frequency band range corresponding to the point with the smallest equivalent node constant can be further determined. For example, the frequency band range can be 4 GHz, and the actual required frequency band range can be 3 GHz. Then, the frequency band range corresponding to the first isolation unit 130 can be reduced when the isolation of the first isolation unit 130 is high. The isolation of the isolation unit 130 can be represented through a transmission parameter. The change trend of the transmission parameter can nearly correspond to the change trend of the equivalent dielectric constant.

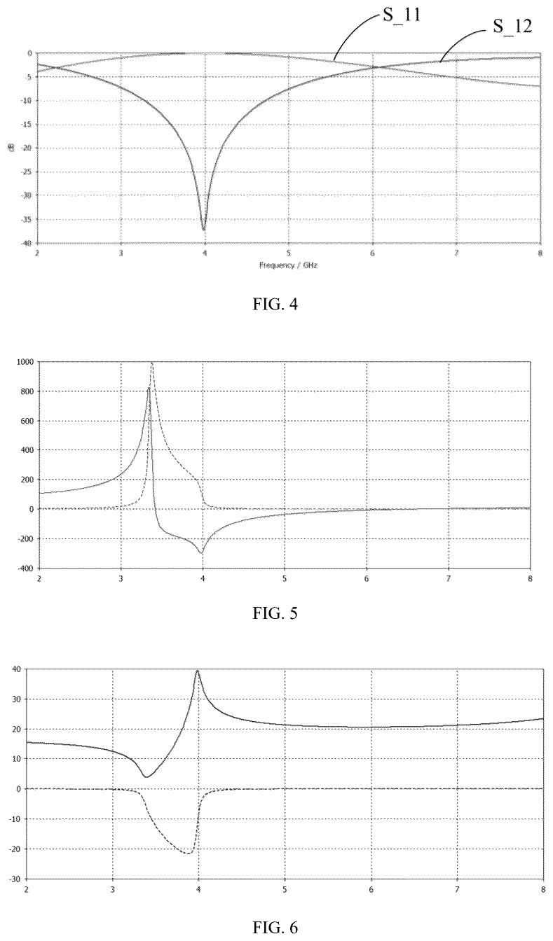

FIG. 4 illustrates a schematic S-parameter curve of the first isolation unit according to some embodiments of the present disclosure.

According to some other embodiments of the present disclosure, to test the isolation effect of the first isolation unit 130, embodiments of the present disclosure can further provide a simulation test for the first isolation unit 130.

The S-parameter simulation results of the first isolation unit 130 are shown in FIG. 4. Curve S_11 represents a scattering parameter, and curve S_12 represents a transmission parameter. In FIG. 4, the first isolation unit 130 has a transmission stopband (S21<−10 dB) in a frequency band of 3.27 GHz to 4.74 GHz. Since the propagation form of the electromagnetic wave of the metamaterial having a single-negative characteristic is the evanescent wave, the energy cannot be effectively transmitted. Then, the first isolation unit 130 can be determined to have the electrical single-negative characteristic near the frequency band.

FIGS. 5 to 7 illustrate schematic curves showing real parts and imaginary parts of the equivalent dielectric constant, the equivalent permeability, and the equivalent refractive index of the first isolation unit according to some embodiments of the present disclosure.

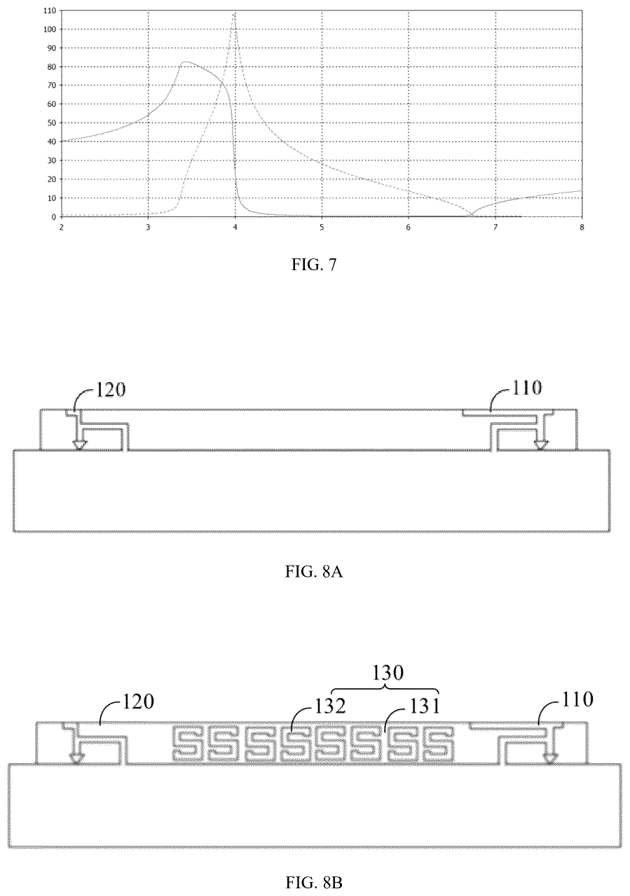

In FIGS. 5 to 7, the values of the equivalent dielectric constant, the equivalent permittivity, and the refractive index of the first isolation unit 130 can be obtained in the S-parameter inversion method. The solid lines represent the real parts, the dashed lines represent the imaginary parts. The unit of the horizontal coordinate is GHz, and the unit of the vertical coordinate is consistent with the equivalent dielectric constant, the equivalent permeability, and the refractive index. In FIG. 5, the equivalent dielectric constant of the first isolation unit 130 is negative in the frequency band range of 3.41 to 7 GHz. In FIG. 6, the equivalent permeability of the first isolation unit 130 is positive. Thus, the first isolation unit 130 can satisfy the electrical single-negative characteristic of the metamaterial. In addition, as shown in FIG. 7, the first isolation unit 130 has a near-zero refractive index characteristic in the frequency band range of 4.5 to 6.7 GHz.

FIG. 8A illustrates a schematic structural diagram of an antenna module without a first isolation unit according to some embodiments of the present disclosure. FIG. 8B illustrates a schematic structural diagram of an antenna module with a first isolation unit according to some embodiments of the present disclosure.

According to another embodiment of the present disclosure, to determine the impact of the first isolation unit 130 on the coupled electromagnetic wave between the first antenna 110 and the second antenna 120 of the electronic device, embodiments of the present disclosure can further provide a simplified simulation model of a notebook antenna. The simulation model is shown in FIGS. 8A and 8B. The antenna module shown in FIG. 8A does not have the first isolation unit 130. Only a conventional dielectric substrate is configured to connect the first antenna 110 and the second antenna 120. The antenna module shown in FIG. 8B is loaded with the first isolation unit 130. The conventional dielectric substrate is used as the substrate 131 of the first isolation unit 130. Additionally, in FIGS. 8A and 8B, a large metal base plate at the bottom is used to simulate the metal shell environment of the notebook to improve the accuracy of the simulation results.

In some embodiments, the following parameters can be taken as an example for simulation. The substrate 131 is made of an FR-4 material with a dielectric constant of 4.3, a loss tangent of 0.02, and a thickness of 0.5 mm. The first antenna 110 and the second antenna 120 can be printed on both sides of the substrate 131, respectively. Eight metal patches 132 of the first isolation unit 130 can be arranged in sequence between the first antenna 110 and the second antenna 120. The distance between two neighboring metal patches 132 can be 2.0 mm. Users can flexibly adjust the number of metal patches 132 and the distance between any two neighboring metal patches 132 according to the actual device environment.

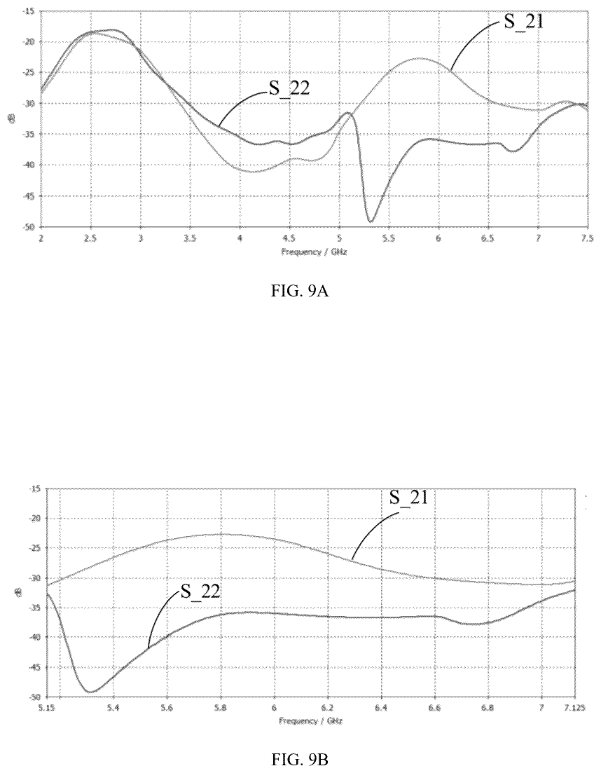

FIG. 9A illustrates a schematic structural diagram of an isolation simulation result curve of the antenna module in a 2-7.5 GHz frequency band according to some embodiments of the present disclosure. FIG. 9B illustrates a schematic structural diagram of an isolation simulation result curve of the antenna module in a 5.15-7.125 GHz frequency band according to some embodiments of the present disclosure.

The change curve of the isolation between the first antenna 110 and the second antenna 120 obtained by performing the simulation on the antenna module shown in FIG. 8 is shown in FIG. 9A and FIG. 9B. The curve S_21 represents the isolation between the antennas before loading the first isolation unit 130, and the curve S_22 represents the isolation between the antennas after loading the first isolation unit 130. In FIGS. 9A and 9B, the first isolation unit 130 causes the isolation between the first antenna 110 and the second antenna 120 to obviously increase in a WiFi high operating frequency band (e.g., a frequency band of 5.15 to 5.85 GHz, and a frequency band of 5.925 to 7.125 GHz). Meanwhile, the isolation performance in a WiFi low operating frequency band (2.4 to 2.5 GHz) may not be impacted. Thus, the first isolation unit 130 can significantly use the isolation performance of the WiFi electronic device, and the operating frequency band can be wide, which covers the whole high-frequency band and satisfies the broadband working requirements of the WiFi electronic device. Thus, the isolation between the antennas in an ultra-wide frequency band can be improved.

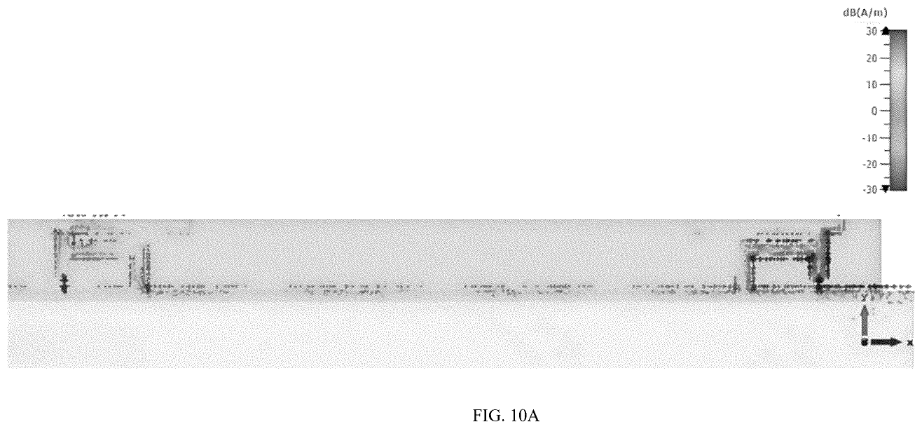

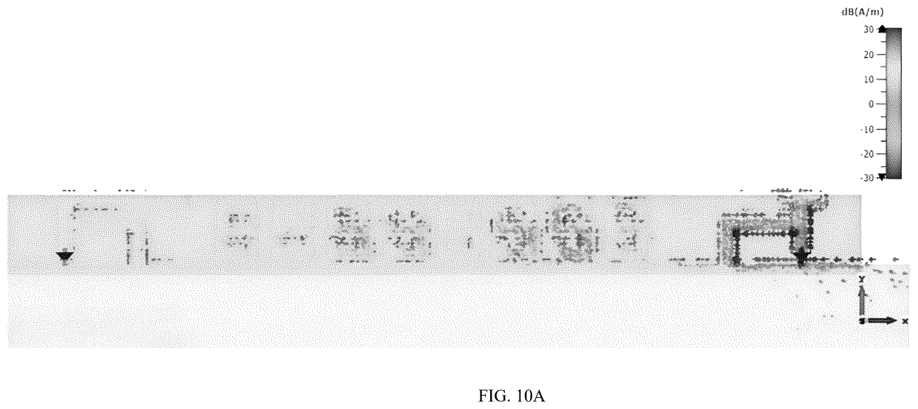

FIG. 10A illustrates a schematic structural diagram of a surface current distribution simulation result of the antenna module without a first isolation unit according to some embodiments of the present disclosure. FIG. 10B illustrates a schematic structural diagram of a surface current distribution simulation result of the antenna module with a first isolation unit according to some embodiments of the present disclosure.

According to some other embodiments of the present disclosure, to analyze the principle of the first isolation unit 130 improving the isolation between the first antenna 110 and the second antenna 120, a simulation analysis is performed on the surface current distributions of the antenna modules shown in FIGS. 8A and 8B.

As shown in FIG. 10A, for the antenna module without loading the first isolation unit 130, when the first antenna 110 on the right is excited, the second antenna 120 on the left can be significantly disturbed. A part of the current can be coupled into the antenna module, which can impact the radiation performance of the second antenna 120.

As shown in FIG. 10B, for the antenna module with the first isolation unit 130, when the first antenna 110 on the right is excited, the surface current distribution of the second antenna 120 on the left is significantly reduced. Most of the coupled current enters the first isolation unit 130 arranged in the middle. Thus, the metamaterial characteristics of the first isolation unit 130 effectively improve the radiation disturbance between the first antenna 110 and the second antenna 120.

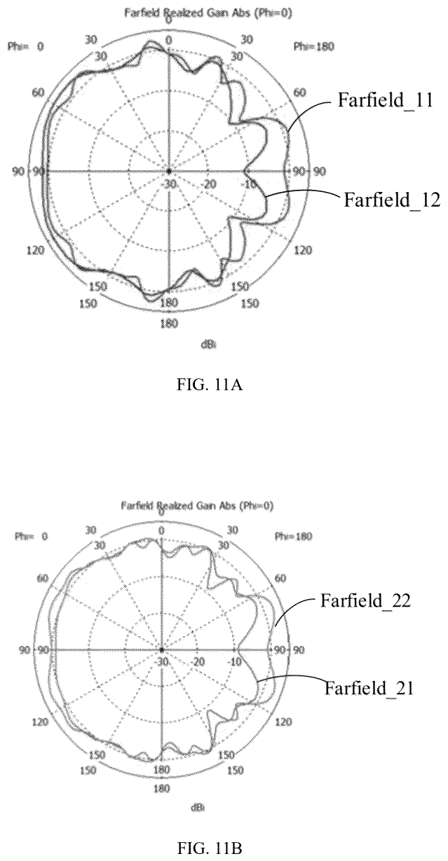

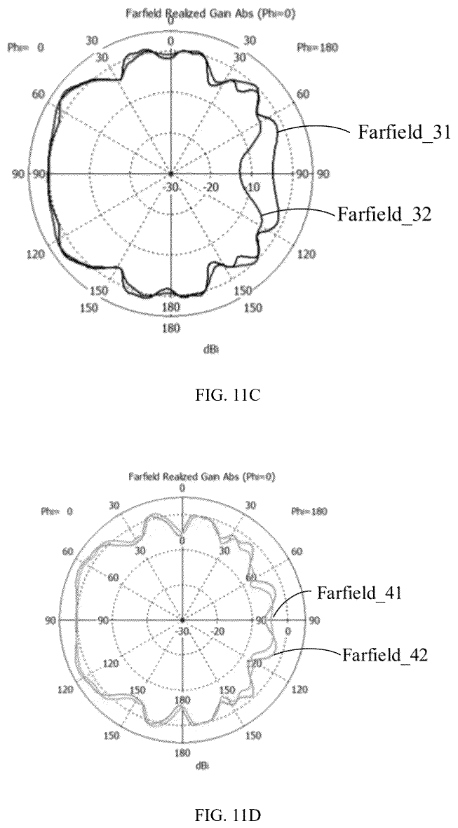

FIG. 11A to FIG. 11D illustrate schematic diagrams of simulation comparison results of an H-plane radiation pattern of the second antenna on the left before and after the first isolation unit is loaded in a 5.5 GHz, 6.0 GHz, 6.5 GHz, and 7.0 GHz.

According to some other embodiments of the present disclosure, to determine the H-plane far-field radiation direction of the second antenna 120 on the left side in FIG. 8B before and after loading the first isolation unit 130, embodiments of the present disclosure can also perform the simulation on the H-plane far-field radiation direction.

Four typical frequencies 5.5 GHz, 6.0 GHz, 6.5 GHz, and 7.0 GHz, simulation can be performed on the H-plane far-field radiation direction of the second antenna 120 on the left before and after loading the first isolation unit 130. The simulation results are shown in FIGS. 11A to 11D. Far-field curves Farfield_11, Farfield_21, Farfield_31, and Farfield_41 represent the far-field radiation conditions before loading the first isolation unit 130, and the far-field curves Farfield_22, Farfield_22, Farfield_32, and Farfield_42 represent the far-field radiation conditions after loading the first isolation unit 130.

As shown in FIGS. 11A to 11D, the outer radiation pattern of the second antenna 120 on the left becomes fuller after loading the first isolation unit 130. The inner radiation pattern contracts slightly. Then, the far-field radiation pattern can be improved. For the first antenna 110 on the right, the outer radiation pattern of the first antenna 110 can be fuller. The inner radiation pattern contracts. Thus, the first antenna 110 on the right and the second antenna 120 on the left can operate simultaneously, and the entire combination of the first antenna 110 and the second antenna 120 can have a better omnidirectional radiation characteristic.

In addition to the above antenna module, the present disclosure further provides an electronic device. The electronic device can be a laptop, a mobile phone, etc. The electronic device can include the above antenna module.

Embodiments of the present disclosure are described above. However, these embodiments are merely for illustrative purposes only and are not intended to limit the scope of the present disclosure. Although embodiments of the present disclosure are described above, the measures in embodiments of the present disclosure do not mean that the measures are not able to be advantageously combined. Without departing from the scope of the present disclosure, those skilled in the art can make various alternatives and modifications, all of which fall within the scope of the present disclosure.

What is claimed is:

1. An antenna module, comprising:
an antenna unit including a first antenna and a second antenna arranged at an interval; and
a first isolation unit arranged between the first antenna and the second antenna and configured to convert a transmission form of an electromagnetic wave coupled into the first isolation unit from the first antenna and/or the second antenna into an evanescent wave, to isolate a target signal between the first antenna and the second antenna.

2. The antenna module according to claim 1, wherein the first isolation unit is capable of electrical resonance to have characteristics with a relative dielectric constant being negative and a permeability being positive, and convert the transmission form of the electromagnetic wave coupled into the first isolation unit into the evanescent wave.

3. The antenna module according to claim 1, wherein:
the first isolation unit includes a subwavelength structure formed by a substrate and a metal patch arranged on the substrate; and/or
a size of the first isolation unit is smaller than a wavelength of the electromagnetic wave generated by the first antenna or the second antenna.

4. The antenna module according to claim 3, wherein:
the metal patch is an S-shaped metal patch; and/or
the substrate is a wave-absorbing material or a flexible dielectric, and the first isolation unit is flexible.

5. The antenna module according to claim 1, wherein:
the antenna module includes a plurality of first isolation units arranged between the first antenna and the second antenna;
each first isolation unit includes a substrate and a metal patch arranged on the substrate; and
a distance between two metal patches of any two neighboring first isolation units is 2.0±0.5 mm.

6. The antenna module according to claim 5, wherein:
the antenna module includes 6 to 8 first isolation units arranged between the first antenna and the second antenna; and/or
a structural size of the metal patch in each first isolation unit is 6±0.2 mm×7.9±0.2 mm.

7. The antenna module according to claim 1, wherein:
the first isolation unit is configured to isolate a signal of the first antenna and/or the second antenna in a frequency band of 5.15 to 5.85 GHz and/or in a frequency band of 5.925 to 7.125 GHz; and/or
the first antenna is a PIFA antenna, the second antenna is a PIFA antenna, and F orientations of the first antenna and the second antenna are opposite.

8. The antenna module according to claim 1, further comprising:
a second isolation unit arranged between the first antenna and the second antenna, configured to deflect a transmission direction of the electromagnetic wave generated by the first antenna or the second antenna, or disrupt interference of the electromagnetic wave to improve isolation between the first antenna and the second antenna.

9. The antenna module according to claim 8, wherein:
the second isolation unit includes a left-handed material with a negative dielectric constant and a negative permeability; and/or
at least two second isolation units are arranged at opposite ends of the first isolation unit facing the first antenna and the second antenna, respectively.

10. An electronic device, comprising an antenna module, including:
an antenna unit including a first antenna and a second antenna arranged at an interval; and
a first isolation unit arranged between the first antenna and the second antenna and configured to convert a transmission form of an electromagnetic wave coupled into the first isolation unit from the first antenna and/or the second antenna into an evanescent wave, to isolate a target signal between the first antenna and the second antenna.

11. The electronic device according to claim 10, wherein the first isolation unit is capable of electrical resonance to have characteristics with a relative dielectric constant being negative and a permeability being positive, and convert the transmission form of electromagnetic wave coupled into the first isolation unit into the evanescent wave.

12. The electronic device according to claim 10, wherein:
the first isolation unit includes a subwavelength structure formed by a substrate and a metal patch arranged on the substrate; and/or
a size of the first isolation unit is smaller than a wavelength of the electromagnetic wave generated by the first antenna or the second antenna.

13. The electronic device according to claim 12, wherein:
the metal patch is an S-shaped metal patch; and/or
the substrate is a wave-absorbing material or a flexible dielectric, and the first isolation unit is flexible.

14. The electronic device according to claim 10, wherein:
the antenna module includes a plurality of first isolation units arranged between the first antenna and the second antenna;
each first isolation unit includes a substrate and a metal patch arranged on the substrate; and
a distance between two metal patches of any two neighboring first isolation units is 2.0±0.5 mm.

15. The electronic device according to claim 14, wherein:
the antenna module includes 6 to 8 first isolation units arranged between the first antenna and the second antenna; and/or
a structural size of the metal patch in each first isolation unit is 6±0.2 mm×7.9±0.2 mm.

16. The electronic device according to claim 10, wherein:
the first isolation unit is configured to isolate a signal of the first antenna and/or the second antenna in a frequency band of 5.15 to 5.85 GHz and/or in a frequency band of 5.925 to 7.125 GHz; and/or
the first antenna is a PIFA antenna, the second antenna is a PIFA antenna, and F orientations of the first antenna and the second antenna are opposite.

17. The electronic device according to claim 10, wherein the antenna module further includes:
a second isolation unit arranged between the first antenna and the second antenna, configured to deflect a transmission direction of the electromagnetic wave generated by the first antenna or the second antenna, or disrupt interference of the electromagnetic wave to improve isolation between the first antenna and the second antenna.

18. The electronic device according to claim 17, wherein:
the second isolation unit includes a left-handed material with a negative dielectric constant and a negative permeability; and/or
at least two second isolation units are arranged at opposite ends of the first isolation unit facing the first antenna and the second antenna, respectively.
